(19) United States
(12) Patent Application Publication
(10) Pub. No.: US 2024/0115453 A1
(43) Pub. Date: Apr. 11, 2024

(54) CASKET FOR SELECTIVELY VIEWING THE DECEASED

(71) Applicants: Rangel Fernandez, Doral, FL (US); Andrea Fernandez, Doral, FL (US)

(72) Inventors: Rangel Fernandez, Doral, FL (US); Andrea Fernandez, Doral, FL (US)

(21) Appl. No.: 18/378,597

(22) Filed: Oct. 10, 2023

Related U.S. Application Data
(60) Provisional application No. 63/414,856, filed on Oct. 10, 2022.

(51) Int. Cl. A61G 17/007; G02F 1/169

(52) U.S. Cl. CPC A61G 17/0136; G02F 1/169

(57) ABSTRACT

A casket includes a base, opposite sides and end walls extending up from the base and a top cover. At least the top cover is formed to have a multilayer construction including a transparent polycarbonate panel and a Suspended Particle Devices (SPD) film composed of several layers and applied to the outer surface of the transparent polycarbonate panel. A bus bar includes two conductors running through the layers of the SPD film. When voltage is applied to the conductors from a battery power source, otherwise randomly arranged particles in the SPD film align themselves in the direction of the electrical field providing transparency to the top cover so that the interior of the casket can be viewed from the exterior.

This non-provisional patent application is based on provisional patent application Ser. No. 63/414,856 filed on Oct. 10, 2022.

### BACKGROUND OF THE INVENTION

### Field of the Invention

The present invention relates to a casket that is at least partially formed of a transparent material that can be quickly and easily changed between an opaque state and a transparent state using Suspended Particle Devices (SPD) film technology.

### Description of the Related Art

When a person dies, it is customary to hold a ceremony to honor the deceased that often includes a religious service in a church, synagogue or other place of worship followed by a burial or cremation. Prior to the formal ceremony, there may be one or more viewing s of the deceased at a funeral home or other location, where friends and family can say their personal goodbyes and pay their respects. This can be the same day as the formal ceremony and, depending on the religion and wishes of family members of the deceased, there may be viewing periods over the course of two to three days prior to the formal ceremony. Throughout the viewing periods and the funeral ceremony, the deceased typically remains in a casket. During the viewing periods, the top of the casket is often opened to allow friends and family members to view the deceased while saying their personal goodbyes. After the viewing periods and throughout the funeral ceremony and burial, the top of the casket is closed.

The present invention provides a unique casket that allows for both viewing of the deceased, as well as privacy when no viewing of the deceased is desired, all without the need to open and close the top of the casket. More particularly, the present invention provides a casket having a top portion that can be easily changed between a transparent (i.e., clear, see-through) state and an opaque state. The top portion of the casket is normally in the opaque state which can be either frosted or a solid color that hides the deceased from view.

### SUMMARY OF THE INVENTION

The present invention is directed to a casket which includes a base, opposite sides and end walls extending up from the base and a top cover. At least the top cover is formed to have a multilayer construction including a transparent polycarbonate layer and a Suspended Particle Devices (SPD) film composed of several layers and applied to the outer surface of the transparent polycarbonate layer. In one embodiment, the SPD film is coated on both sides (i.e., top and bottom) with a transparent conductive material of Indium Tin Oxide (ITO). A bus bar includes two conductors that extend through the top and bottom coatings of ITO on opposite sides of the SPD film. When voltage is applied to the conductors from a battery power source, otherwise randomly arranged particles in the SPD film align themselves in the direction of the electrical field. This creates transparency to the top cover so that the interior of the casket can be viewed from the exterior.

### BRIEF DESCRIPTION OF THE DRAWINGS

For a fuller understanding of the nature of the present invention, reference should be had to the following detailed description taken in connection with the accompanying drawings in which:

FIG. 1 is a top perspective view showing the casket of the present invention wherein the top portion is in a transparent state so that the interior of the casket is easily viewed from the exterior;

FIG. 2 is a top perspective view of the casket of the present invention shown with the top portion in an opaque state to provide privacy so that the interior of the casket cannot be seen from the exterior;

FIG. 3A is a perspective view showing the casket with the top portion in the opaque state, preventing viewing of the interior of the casket;

FIG. 3B is a perspective view showing the casket in the transparent state to allow viewing of the interior of the casket from the exterior; and

FIG. 4 is an isolated view, in partial cross section, illustrating the structure of the top portion of the casket that changes between the transparent state and the opaque state, and wherein the top portion of the casket includes a translucent or transparent polycarbonate layer and a SPD film applied to the exterior of the polycarbonate and including a bus bar for delivering an electric current through the film, and wherein the SPD film includes at least one SPD (Suspended Particle Devices) layer and at least one ITO (Iridium Tin Oxide) layer.

Like reference numerals refer to like parts throughout the several views of the drawings.

### DETAILED DESCRIPTION OF THE PREFERRED EMBODIMENT

Referring to the several views of the drawings, the present invention is directed to a casket 10 that has a base 12, opposite side walls 14 extending up from the base 12, opposite end walls 16 extending up from the base 12, and a top portion 20. The top portion 20 includes a polycarbonate panel (i.e., layer) that is quickly and easily changed from an opaque state to a transparent state when electric current is applied to a bus bar 40 having conductors 42 and 44 running through a Suspended Particle Devices (SPD) composite film 30 that covers the outer or inner surface of the polycarbonate panel 22. As seen throughout the several views of the drawings, the polycarbonate layer may be formed in a curved or generally semicylindrical configuration. However, it is recognized that other shapes and configurations of the polycarbonate layer 22 are fully contemplated within the invention, including a flat top panel, as well as angled side panels and a top panel are all formed of a polycarbonate material.

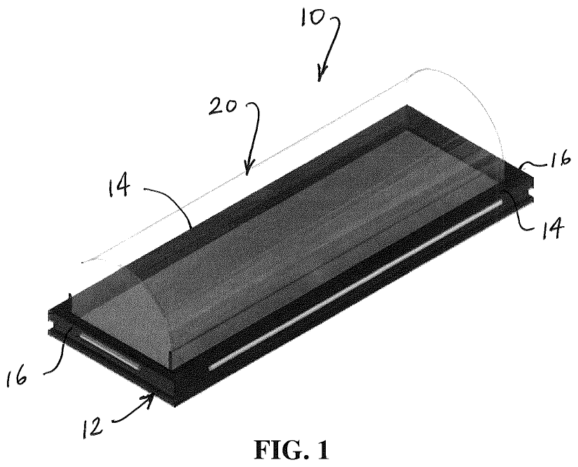

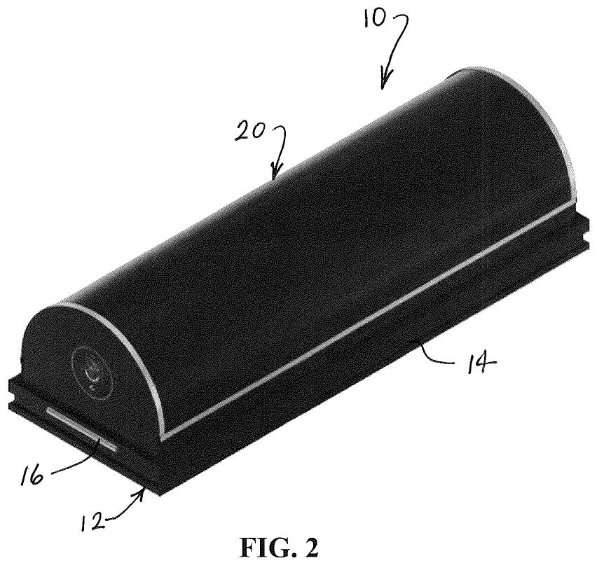

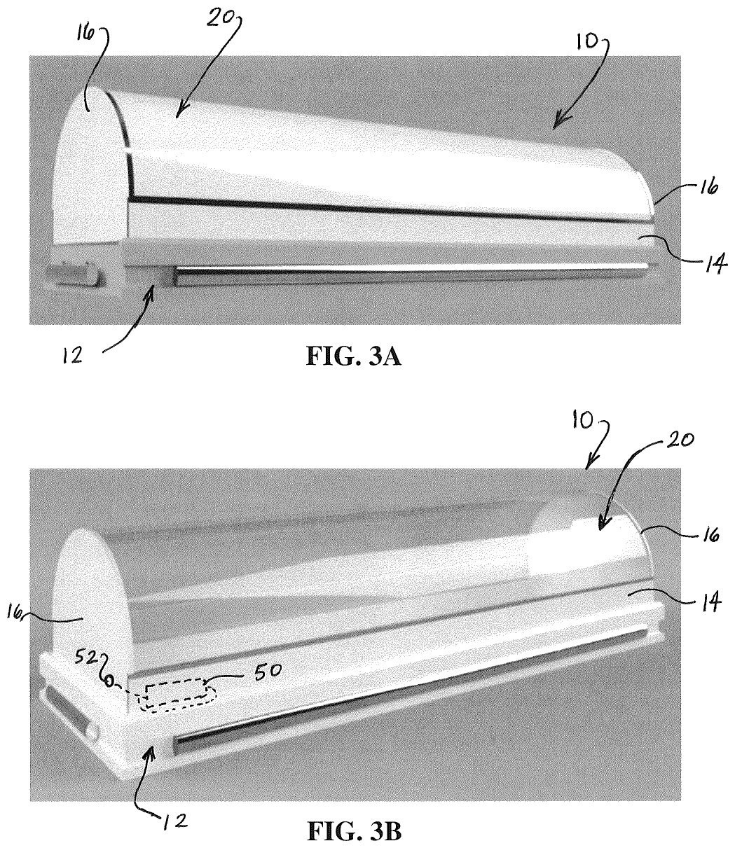

As seen in FIGS. 1 and 3B, the polycarbonate layer 22 is in a clear or transparent state when voltage is applied to the SPD film 30 on the polycarbonate layer 22. As seen in FIGS. 2 and 3A, the top polycarbonate layer 22 can be easily changed to the translucent or opaque state when the applied voltage is interrupted or stopped.

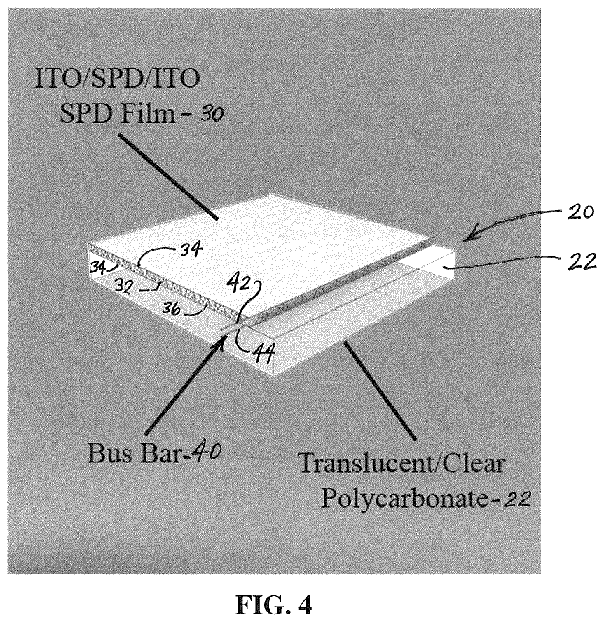

Referring to FIG. 4, the construction of the top portion 20 of casket 10 is shown, and includes a polycarbonate layer 22 that is normally a transparent material. The SPD composite film 30 is applied to the outer surface of the normally transparent polycarbonate layer 22. The SPD composite film 30 is composed of several layers including at least one Iridium Tin Oxide (ITO) layer 34 and at least one inner layer of SPD plastic film 32. In the preferred embodiment, the SPD plastic film layer 32 is coated on both sides with the transparent, conductive material of Indium Tin Oxide (ITO) layer 34. The bus bar 40 includes two conductors 42 and 44. One conductor 42 extends through the top coating (layer) of ITO material 34 and the other conductor 44 extends through the bottom coating (layer) of ITO material 34 with the SPD plastic film layer 32 sandwiched between the top and bottom ITO layers. The SPD film layer includes particles 36 which may be rod-shaped and suspended in an organic gel. The gel is a non-aqueous, electrically-resistive liquid with a polymeric stabilizer dissolved in it. The rod-shaped SPD particles 36 orient themselves randomly when there is no electric voltage applied, thus absorbing, reflecting or transmitting any incoming light. In this state, the SPD film layer 32 blocks light and creates an opaque appearance which may be of any desired color. When electric current is applied to the conductors 42 and 44 and the ITO layer(s) 34, the rod-shaped particles 36 align themselves in the direction of the electric field created by the electric current passing between the top and bottom layers of ITO coating. When the rod-shaped particles 36 in the SPD film layer 32 are aligned, light is able to pass through the SPD composite film 30 providing transparency so that the interior of the casket can be viewed from the exterior, through the polycarbonate top portion 20 of the casket 10.

The bus bar 40 is electrically connected, in electric conductivity to an electric power source, such as a battery power source 50 in the casket 10. A button 52 or other actuator may be used to close the circuit to direct electric current through the bus bar and thereby turning the SPD composite film 30 transparent. Upon operation of the button 52 or other actuator, the circuit can be opened, interrupting current flow through the bus bar 40 and conductors 42 and 44, and thereby causing the rod-shaped particles 36 to be randomly oriented, thereby absorbing and reflecting light and creating the opaque or translucent appearance to the polycarbonate top portion 20 of the casket 10.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A casket comprising:
a base and at least a top portion covering the base to enclose an interior of the casket, and the top portion including at least one panel including a layer of transparent material, and the at least one panel further including a suspended particle devices composite film covering an exposed surface of the layer of transparent material; and
electrical conductors extending through the suspended particle devices composite film for applying electric current to the suspended particle devices composite film to cause the at least one panel to change from a normally opaque state to a transparent state and allowing the interior of the casket to be viewed from an exterior of the casket.

2. The casket as recited in claim 1 wherein the suspended particle devices composite film includes at least one indium tin oxide layer and at least one suspended particle devices film layer.

3. The casket as recited in claim 2 wherein the suspended particle devices film layer further includes a non-aqueous electrically resistive gel and a plurality of particles suspended in the gel, and the plurality of particles normally being randomly arranged throughout the gel causing the at least one panel of the top portion to be in an opaque state to prevent viewing of the interior of the casket from an exterior of the casket, and the plurality of particles being influenced by the electric current applied to the suspended particle devices film to cause the plurality of particles to be aligned in the direction of the electric field created by the current passing through the indium tin oxide layer, and allowing light to pass through the suspended particle devices composite film to provide transparency to the at least one panel of the top portion of the casket.

4. The casket as recited in claim 3 further comprising:
a battery power source for supplying the electric current to the electrical conductors for direction through the suspended particle devices composite film.

5. The casket as recited in claim 4 further comprising:
an actuator switch operable to close an electrical circuit between the battery power source and the electrical conductors to thereby change the at least one panel from the normally opaque state to the transparent state, and the actuator switch being further operable to open a circuit between the battery power source and the electrical conductors to interrupt current flow to the suspended particle devices composite film and thereby causing the at least one panel to change back to the normally opaque state.
